(19) United States
(12) Patent Application Publication
(10) Pub. No.: US 2022/0234886 A1
(43) Pub. Date: Jul. 28, 2022

(54) AMMONIA DECOMPOSITION CATALYST AND AMMONIA DECOMPOSITION METHOD USING THE SAME

(71) Applicant: TOYOTA JIDOSHA KABUSHIKI KAISHA, Toyota-shi (JP)

(72) Inventors: Kiyoshi YAMAZAKI, Nagakute-shi (JP); Akinori SATOU, Mishima-shi (JP)

(73) Assignee: TOYOTA JIDOSHA KABUSHIKI KAISHA, Toyota-shi (JP)

(21) Appl. No.: 17/582,483

(22) Filed: Jan. 24, 2022

(30) Foreign Application Priority Data
Jan. 27, 2021 (JP) 2021-011400

(51) Int. Cl. C01B 3/04; B01J 23/63

(52) U.S. Cl. CPC C01B 3/047; C01B 2203/0277; B01J 23/63

(57) ABSTRACT

An ammonia decomposition catalyst contains a carrier containing a composite oxide of cerium (Ce) and praseodymium (Pr), and ruthenium (Ru), and the content of the composite oxide is 70 mass % or more with respect to the entire catalyst, and the molar ratio between Ce and Pr in the composite oxide is Ce:Pr=99:1 to 10:90.

### INCORPORATION BY REFERENCE

This application claims priority to Japanese Patent Application No. 2021-011400 filed on Jan. 27, 2021, incorporated herein by reference in its entirety.

### BACKGROUND

### 1. Technical Field

The present disclosure relates to an ammonia decomposition catalyst and an ammonia decomposition method using the same, and more specifically, to an ammonia decomposition catalyst containing ruthenium and an ammonia decomposition method using the same.

### 2. Description of Related Art

In recent years, in order to protect the environment, a technology for utilizing hydrogen as a clean energy source has been focused on, and for example, the development of automobiles that are driven by fuel cells using hydrogen as a fuel has been actively performed. However, since hydrogen is very light in a gaseous state, a storage method and a transport/supply method are problematic. For example, as a method of storing hydrogen gas itself, a method of compressing or liquefying hydrogen and storing it and a method of using a hydrogen storage alloy have been studied, but there are problems in the storage capacity, cost, safety and the like. Therefore, as a new hydrogen supply method, a method in which liquid ammonia is stored and transported, this ammonia is decomposed using a catalytic reaction, and the generated hydrogen is supplied has been studied, and various ammonia decomposition catalysts for that purpose have been proposed. In particular, in polymer electrolyte fuel cells, since ammonia remaining in the ammonia decomposition reaction damages the cells, it is necessary to almost completely decompose ammonia, and there is a demand for an ammonia decomposition catalyst having a very strong catalytic activity.

In addition, in consideration of thermal efficiency, when a heat exchange type reaction device in which a part generating heat due to an oxidation reaction of ammonia or hydrogen and a part absorbing heat from a decomposition reaction of ammonia are integrated is used as an ammonia decomposition reaction device, an ammonia decomposition catalyst is required to exhibit a very strong ammonia decomposition activity under conditions of a low reaction temperature (for example, 500° C.) in order to reduce heat energy consumption in the heat generation part, and is required to exhibit excellent heat resistance (for example, 600° C. or higher) in order to minimize thermal degradation of the catalyst due to heat conduction in the reaction device. In addition, in order to reduce the size of the reaction device in consideration of cost, the ammonia decomposition catalyst is required to exhibit a very strong ammonia decomposition activity under conditions of a high space velocity of ammonia gas (for example, 30,000 h⁻¹).

Japanese Unexamined Patent Application Publication No. 2009-254981 (JP 2009-254981 A) discloses an ammonia decomposition catalyst containing Group 8 to Group 10 elements such as ruthenium and low acid strength oxides such as cerium oxide and magnesium oxide. However, in the ammonia decomposition catalyst, since the ruthenium particle size is large, and ruthenium and the like are not sufficiently dispersed and supported, the number of active sites is small, and under conditions of a low reaction temperature and conditions of a high space velocity of ammonia gas, a strong ammonia decomposition activity is not obtained.

In addition, Japanese Unexamined Patent Application Publication No. 2016-159209 (JP 2016-159209 A) discloses an ammonia decomposition catalyst containing a magnesium oxide carrier containing basic magnesium carbonate and ruthenium supported on the carrier. However, in the ammonia decomposition catalyst, ruthenium as an active site is supported while highly dispersed, but magnesium oxide as a carrier has a low density, and thus the catalyst volume per catalyst mass is large and a strong ammonia decomposition activity is not obtained under conditions of a high space velocity of ammonia gas.

In addition, Japanese Unexamined Patent Application Publication No. 2018-1096 (JP 2018-1096 A) discloses a catalyst for ammonia decomposition containing a metal element such as ruthenium belonging to Group 8 to Group 10 in the periodic table, a composite oxide of an oxide of a rare earth element and zirconia, and a heat resistant oxide containing alumina. However, in the catalyst for ammonia decomposition, since the reaction rate per active site with ruthenium supported on alumina or zirconia having a relatively high acid strength is lower than the reaction rate per active site with ruthenium supported on an oxide of a rare earth element, a strong ammonia decomposition activity is not obtained under conditions of a low reaction temperature of the entire catalyst and under conditions of a high space velocity of ammonia gas.

In addition, K. Nagaoka et al., International Journal of Hydrogen Energy, 2014, Vol. 39, No. 35, pp. 20731 to 20735, disclose an ammonia decomposition catalyst in which ruthenium (Ru) is supported on praseodymium oxide (Pr₆O₁₁) and an ammonia decomposition catalyst in which an alkali metal oxide, an alkaline earth metal oxide, or a rare earth oxide is doped into the catalyst. However, in the ammonia decomposition catalyst, ruthenium is not sufficiently dispersed and supported, and the thermal stability of praseodymium oxide is low, and when exposed to a high temperature, ruthenium particles grow, the particle size becomes large, and thus the number of active sites decreases, and a strong ammonia decomposition activity is not obtained under conditions of a low reaction temperature and under conditions of a high space velocity of ammonia gas.

### SUMMARY

The present disclosure provides an ammonia decomposition catalyst exhibiting a very strong ammonia decomposition activity under conditions of a high space velocity of ammonia gas (for example, 30,000 h⁻¹) and a low reaction temperature (for example, 500° C.), and particularly under these conditions even after exposure to a high temperature (for example, 600° C. or higher). In addition, the present disclosure provides an ammonia decomposition method in which, under these conditions, it is possible to efficiently decompose ammonia and generate hydrogen.

In order to achieve the above objects, the inventors conducted extensive studies and as a result, found that, when an ammonia decomposition catalyst containing a carrier containing a composite oxide of cerium (Ce) and praseodymium (Pr) in a specific molar ratio, and ruthenium (Ru) is used, it is possible to efficiently decompose ammonia under conditions of a high space velocity of ammonia gas (for example, 30,000 h⁻¹) and a low reaction temperature (for example, 500° C.), and particularly under these conditions even after exposure to a high temperature (for example, 600° C. or higher), and completed the present disclosure.

That is, the ammonia decomposition catalyst of the present disclosure is an ammonia decomposition catalyst containing a carrier containing a composite oxide of cerium (Ce) and praseodymium (Pr), and ruthenium (Ru), the content of the composite oxide with respect to the entire catalyst being 70 mass % or more, and the molar ratio between Ce and Pr in the composite oxide being Ce:Pr=99:1 to 10:90.

In the ammonia decomposition catalyst of the present disclosure, preferably, the Ru content is 0.1 parts by mass to 10 parts by mass with respect to 100 parts by mass of the composite oxide.

In addition, the ammonia decomposition method of the present disclosure is a method including bringing ammonia into contact with the ammonia decomposition catalyst according to claim 1 and decomposing the ammonia in a temperature range of 450° C. to 650° C.

Here, the reason why the ammonia decomposition catalyst of the present disclosure exhibits a very strong ammonia decomposition activity under conditions of a high space velocity of ammonia gas (for example, 30,000 h⁻¹) and a low reaction temperature (for example, 500° C.), and particularly under these conditions even after exposure to a high temperature (for example, 600° C. or higher) is not completely clear, but the inventors speculate it to be as follows. That is, the ammonia decomposition catalyst of the present disclosure contains a carrier containing a composite oxide of cerium (Ce) and praseodymium (Pr), and ruthenium (Ru). It is inferred that, in such an ammonia decomposition catalyst, since Ru exhibits a strong interaction with a composite oxide of Ce and Pr (in particular, praseodymium oxide in the composite oxide), the Ru particle size during catalyst production decreases and the number of active sites contributing to the decomposition reaction of ammonia increases. In addition, it is inferred that, like cerium oxide, since the composite oxide of Ce and Pr has a relatively large specific surface area (10 m²/g to 100 m²/g), highly dispersed (preferably, supported) Ru (active site) is contained. In addition, it is inferred that, since the quality of the active sites is improved due to an action of electrons from a composite oxide of Ce and Pr (in particular, praseodymium oxide in the composite oxide) on Ru, the reaction rate (turnover frequency) per active site is improved. In this manner, it is inferred that, in the ammonia decomposition catalyst of the present disclosure, since many highly dispersed active sites with favorable quality are present, a very strong ammonia decomposition activity is obtained under conditions of a low reaction temperature. In addition, it is inferred that, like cerium oxide and praseodymium oxide, the composite oxide of Ce and Pr as a material itself has a higher density (6.6 g/cm³ to 7.3 g/cm³) than magnesium oxide and the like, and when used as a pellet catalyst or the like, the volume per catalyst mass can be reduced, and thus the ammonia decomposition catalyst of the present disclosure exhibits a very strong ammonia decomposition activity under conditions of a high space velocity of ammonia gas.

In addition, it is inferred that, in the ammonia decomposition catalyst of the present disclosure, since Ru exhibits a strong interaction with a composite oxide of Ce and Pr (in particular, praseodymium oxide in the composite oxide), even after exposure to a high temperature, the Ru particles are unlikely to grow, many active sites with favorable quality are retained, and very strong ammonia decomposition activity is exhibited.

According to the present disclosure, it is possible to obtain an ammonia decomposition catalyst exhibiting a very strong ammonia decomposition activity under conditions of a high space velocity of ammonia gas (for example, 30,000 h⁻¹) and a low reaction temperature (for example, 500° C.), and particularly under these conditions even after exposure to a high temperature (for example, 600° C. or higher), and it is possible to efficiently decompose ammonia and generate hydrogen under the conditions, and particularly under these conditions even after exposure to a high temperature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the Ru particle size of ammonia decomposition catalysts obtained in Example 1 and Comparative Example 1;

FIG. 2 is a graph showing the Ru particle size of ammonia decomposition catalysts obtained in Example 2 and Comparative Examples 2 to 4;

FIG. 3 is a graph showing the conversion rate of ammonia by ammonia decomposition catalysts obtained in Example 1 and Comparative Example 1;

FIG. 4 is a graph showing the conversion rate of ammonia by ammonia decomposition catalysts obtained in Example 2 and Comparative Examples 2 to 4; and

FIG. 5 is a graph showing the relationship between a praseodymium content and an ammonia conversion rate in ammonia decomposition catalysts obtained in Examples 2 to 6 and Comparative Examples 2 to 3.

### DETAILED DESCRIPTION OF EMBODIMENTS

Hereinafter, preferable embodiments of the present disclosure will be described in detail.

Ammonia Decomposition Catalyst

First, an ammonia decomposition catalyst of the present disclosure will be described. The ammonia decomposition catalyst of the present disclosure is an ammonia decomposition catalyst containing a carrier containing a composite oxide of cerium (Ce) and praseodymium (Pr), and ruthenium (Ru), and the content of the composite oxide is 70 mass % or more with respect to the entire catalyst, and the molar ratio between Ce and Pr in the composite oxide is Ce:Pr=99:1 to 10:90. Such an ammonia decomposition catalyst of the present disclosure exhibits a very strong ammonia decomposition activity under conditions of a high space velocity of ammonia gas and a low reaction temperature, and particularly under these conditions even after exposure to a high temperature.

The ammonia decomposition catalyst of the present disclosure contains a carrier containing a composite oxide of Ce and Pr. The carrier is not particularly limited as long as it contains a composite oxide of Ce and Pr, and may further contain a metal oxide other than cerium oxide and praseodymium oxide. Examples of such other metal oxides include aluminum oxide, magnesium oxide, zirconium oxide, titanium oxide, and silicon oxide. In addition, such other metal oxides may form a composite oxide of cerium oxide and praseodymium oxide (that is, the carrier may be a composite oxide of Ce, Pr and another metal), or may be contained in the carrier independently of the composite oxide of Ce and Pr (that is, the carrier may be a mixture of a composite oxide of Ce and Pr and another metal oxide).

In the ammonia decomposition catalyst of the present disclosure, the content of the composite oxide is 70 mass % or more with respect to the entire catalyst. An ammonia decomposition catalyst in which the content of the composite oxide is within the above range exhibits a very strong ammonia decomposition activity under conditions of a high space velocity of ammonia gas and a low reaction temperature, and particularly under these conditions even after exposure to a high temperature. On the other hand, when the content of the composite oxide is less than the lower limit, since the interaction between Ru and the composite oxide (in particular, praseodymium oxide in the composite oxide) is weakened, the particle size of Ru becomes large during catalyst production, and during exposure to a high temperature, the Ru particles grow, the number of active sites decreases, and the specific surface area of the carrier decreases. Therefore, the degree of dispersion of the active sites decreases, and additionally the electronic action from the composite oxide (in particular, praseodymium oxide in the composite oxide) to Ru is weakened, and the quality of the active sites deteriorates, and thus the reaction rate (turnover frequency) per active site decreases, and the proportion of Ru and metal oxides other than the composite oxide increases, and thus the volume of the entire catalyst increases. Therefore, the ammonia decomposition activity under conditions of a high space velocity of ammonia gas and a low reaction temperature, particularly under these conditions after exposure to a high temperature, deteriorates. In addition, in order to improve the ammonia decomposition activity under conditions of a high space velocity of ammonia gas and a low reaction temperature, particularly under these conditions after exposure to a high temperature, the content of the composite oxide is preferably 80 mass % or more, more preferably 90 mass % or more, particularly preferably 95 mass % or more, and most preferably 100 mass %.

In addition, in the ammonia decomposition catalyst of the present disclosure, the molar ratio between Ce and Pr in the composite oxide is Ce:Pr=99:1 to 10:90. An ammonia decomposition catalyst in which the molar ratio between Ce and Pr is within the above range exhibits a very strong ammonia decomposition activity under conditions of a low reaction temperature (in particular, even after exposure to a high temperature). On the other hand, when the molar ratio between Ce and Pr is less than the lower limit (that is, the proportion of Pr is less than the lower limit), since the interaction between Ru and the composite oxide (in particular, praseodymium oxide in the composite oxide) is weakened, the particle size of Ru becomes large during catalyst production, and during exposure to a high temperature, the Ru particles grow, the number of active sites decreases, and the electronic action from the composite oxide (in particular, praseodymium oxide in the composite oxide) to Ru is weakened, the quality of the active sites deteriorates, and thus the reaction rate (turnover frequency) per active site decreases. On the other hand, when the molar ratio between Ce and Pr exceeds the upper limit (that is, the proportion of Pr exceeds the upper limit), since the proportion of Ce is relatively small, it is not possible for the composite oxide to maintain a large specific surface area during exposure to a high temperature, and as a result, the Ru particles supported on the composite oxide grow and the number of active sites decreases. In addition, the electronic action on Ru is too strong, the proportion of Ru in an oxide state increases, and the ammonia decomposition activity deteriorates. In addition, in order to improve the ammonia decomposition activity under conditions of a low reaction temperature (in particular, even after exposure to a high temperature), the molar ratio between Ce and Pr is preferably 99:1 to 25:75, and particularly preferably 98:2 to 33:67.

The ammonia decomposition catalyst of the present disclosure contains such a carrier and ruthenium (Ru), and Ru is preferably supported on the carrier. This Ru serves as an active site in the ammonia decomposition reaction, ammonia is decomposed, and hydrogen is generated.

In the ammonia decomposition catalyst of the present disclosure, the Ru content (preferably, a supported amount) is preferably 0.1 parts by mass to 10 parts by mass and more preferably 0.5 parts by mass to 5 parts by mass with respect to 100 parts by mass of the composite oxide. When the Ru content is less than the lower limit, a sufficient ammonia decomposition activity is unlikely to be obtained, and on the other hand, when the Ru content exceeds the upper limit, Ru sintering is likely to occur, the dispersity of Ru (active site) decreases, the ammonia decomposition activity is not improved, and it tends to be disadvantageous in terms of cost.

The particle size of Ru is not particularly limited, and is preferably 0.5 nm to 50 nm, and more preferably 1 nm to 20 nm. When the particle size of Ru is less than the lower limit, it tends to be difficult to use Ru in a highly active metal state, and on the other hand, when the particle size of Ru exceeds the upper limit, the number of active sites decreases and the ammonia decomposition activity tends to deteriorate.

In addition, the dispersity of Ru is not particularly limited, and is preferably 2% to 90%, and more preferably 5% to 90%. When the dispersity of Ru is less than the lower limit, the number of active sites decreases, and the ammonia decomposition activity tends to deteriorate, and on the other hand, when the dispersity exceeds the upper limit, it tends to be difficult to maintain Ru in a highly active metal state.

The form of the ammonia decomposition catalyst of the present disclosure is not particularly limited, and examples thereof include a honeycomb-shaped monolith catalyst and a pellet-shaped pellet catalyst. In addition, a powdered catalyst may be used without change. When the ammonia decomposition catalyst of the present disclosure is used in the form of a pellet catalyst, the average particle size is not particularly limited, and is preferably 0.1 mm to 50 mm, and more preferably 0.2 mm to 20 mm. In addition, when the powdered ammonia decomposition catalyst is used without change, the average particle size is not particularly limited, and is preferably 0.01 μm to 100 μm, and more preferably 0.05 μm to 50 μm.

The method of producing such an ammonia decomposition catalyst of the present disclosure is not particularly limited, and examples thereof include a method in which, in a solution containing a Ce salt and a Pr salt in a predetermined ratio, a precipitate containing Ce and Pr in a predetermined ratio is produced, the precipitate is fired to form a carrier containing a composite oxide of Ce and Pr, a solution containing a Ru salt is impregnated into the carrier and then dried, and Ru is supported on the carrier (impregnation method) and a method in which, in a solution containing a Ce salt, a Pr salt and a Ru salt in a predetermined ratio, a precipitate containing Ce, Pr and Ru in a predetermined ratio is produced, the precipitate is fired, and a catalyst containing a carrier containing a composite oxide of Ce and Pr, and Ru (preferably, Ru is supported on the carrier) is obtained (coprecipitation method).

Examples of Ce salts include sulfates, nitrates, chlorides, acetates, and complexes. Examples of Pr salts include sulfates, nitrates, chlorides, acetates, and complexes. Examples of Ru salts include chlorides, acetates, nitrates, ammonium salts, citrates, dinitrodiammine salts, nitrosyl nitrates, and complexes.

In the impregnation method, when a precipitate containing Ce and Pr in a solution containing a Ce salt and a Pr salt is produced, it is preferable to add urea to the solution containing the Ce salt and the Pr salt. Thereby, a precipitate with a more uniform size, shape, and composition is produced.

In addition, in the coprecipitation method, when a precipitate containing Ce, Pr and Ru is produced in a solution containing a Ce salt, a Pr salt, and a Ru salt, it is preferable to add an alkali metal or ammonium carbonate to the solution containing the Ce salt, the Pr salt and the Ru salt. The alkali metal or ammonium carbonate acts as a precipitating agent, and a loosely bonded precipitate of a composite oxide of Ce and Pr and ruthenium hydroxide in a highly dispersed state is obtained.

In addition, the ammonia decomposition catalyst of the present disclosure is preferably subjected to a reduction treatment before it is used in an ammonia decomposition reaction. Thereby, hydrogen and nitrogen can be generated from ammonia gas more efficiently. This is thought to be caused by the fact that ruthenium is reduced from an oxide state to a highly active metal state according to the reduction treatment, and the ammonia decomposition activity is improved.

The reduction treatment may be performed using a reducing gas such as hydrogen gas, ammonia gas, hydrazine gas, and carbon monoxide, or may be performed using ammonia gas that is used in an ammonia decomposition reaction. In addition, a reducing gas that is mixed with nitrogen gas or an inert gas such as argon gas may be used. The reduction treatment temperature is preferably 500° C. to 600° C., and the reduction treatment time is preferably 0.1 hours to 10 hours.

Ammonia Decomposition Method

An ammonia decomposition method of the present disclosure is a method in which, in a temperature range of 450° C. to 650° C., ammonia is brought into contact with the ammonia decomposition catalyst of the present disclosure, the ammonia is decomposed, and hydrogen and nitrogen are produced. Therefore, the ammonia decomposition method of the present disclosure is useful not only as a method in which ammonia as a harmful substance is decomposed but also as a method in which hydrogen as a clean energy source is produced.

In the ammonia decomposition method of the present disclosure, the decomposition reaction temperature is 450° C. to 650° C., and preferably 450° C. to 550° C. Since the ammonia decomposition catalyst of the present disclosure exhibits a strong ammonia decomposition activity under conditions of such a low decomposition reaction temperature, in the ammonia decomposition method of the present disclosure, it is possible to efficiently decompose ammonia and generate hydrogen under such conditions of such a low decomposition reaction temperature.

In addition, in the ammonia decomposition method of the present disclosure, the space velocity of the ammonia gas is preferably 5,000 h⁻¹ to 60,000 h⁻¹ and more preferably 15,000 h⁻¹ to 45,000 h⁻¹. Since the ammonia decomposition catalyst of the present disclosure exhibits a strong ammonia decomposition activity under conditions of a high space velocity of such ammonia gas, in the ammonia decomposition method of the present disclosure, it is possible to efficiently decompose ammonia and generate hydrogen under conditions of a high space velocity of such ammonia gas.

While the present disclosure will be described below in more detail with reference to examples and comparative examples, the present disclosure is not limited to the following examples.

### Example 1

First, 9.14 g of diammonium cerium nitrate (IV), 3.63 g of praseodymium nitrate (III) hexahydrate, and 24 g of urea were dissolved in 200 g of deionized water. The obtained aqueous solution was stirred for 8 hours while keeping the temperature at 100° C. Thereby, urea was decomposed to produce ammonia, and a precipitate was additionally produced. The precipitate was collected by filtration and then washed with boiling water (100° C.). The solid component after washing was dried at 110° C. for 17 hours and then fired in the atmosphere at 650° C. for 8 hours to obtain a composite oxide. The molar ratio between Ce and Pr in the composite oxide was Ce:Pr=67:33.

Next, 0.128 g of dodecacarbonyltriruthenium (0) was dissolved in 75 g of tetrahydrofuran. 4 g of the composite oxide was added to the obtained solution with stirring and immersed, and the solution was impregnated into the composite oxide and then evaporated and dried at room temperature. The obtained dry component was dried at 80° C. for 16 hours to obtain a powdered solid component. The solid component was powder-molded at a hydraulic pressure of 250 kgf/cm² and then crushed and the particle size was regulated so that the pellet diameter was in a range of 0.35 mm to 0.71 mm, and thereby a pellet catalyst was obtained. The Ru content in the pellet catalyst was 1.5 parts by mass with respect to 100 parts by mass of the composite oxide. In addition, the obtained pellet catalyst was put into a graduated cylinder, the mass and the volume were measured, and the density of the pellet catalyst was calculated as 1.87 g/cm³.

### Example 2

0.609 g of ruthenium chloride, and predetermined amounts of cerium nitrate (III) hexahydrate and praseodymium nitrate (III) hexahydrate were dissolved in 200 ml of deionized water so that, in the catalyst containing a carrier containing a composite oxide of Ce and Pr, and Ru, the Ru content was 3 parts by mass with respect to 100 parts by mass of the composite oxide, and the molar ratio between Ce and Pr was Ce:Pr=67:33. An aqueous solution prepared by dissolving 12.6 g of potassium carbonate in 200 ml of deionized water was gradually added to the obtained aqueous solution with vigorous stirring. Thereby, a precipitate was produced. Here, the amount of potassium carbonate in this case was determined so that the total number of moles of potassium was three times the number of moles of ruthenium, four times the number of moles of cerium, and three times the number of moles of praseodymium. The produced precipitate was left at room temperature for 24 hours and aged and then collected by filtration, and additionally washed. The solid component after washing was dried at 110° C. for 17 hours and then fired in the atmosphere at 500° C. for 2 hours to obtain a powdered solid component. The solid component was powder-molded at a hydraulic pressure of 250 kgf/cm² and then crushed and the particle size was regulated so that the pellet diameter was in a range of 0.35 mm to 0.71 mm, and thereby a pellet catalyst was obtained. When the density of the pellet catalyst was measured in the same manner as in Example 1, it was 0.95 g/cm³.

### Example 3

A pellet catalyst was obtained in the same manner as in Example 2 except that the amounts of cerium nitrate (III) hexahydrate and praseodymium nitrate (III) hexahydrate were changed so that, in the catalyst containing a carrier containing a composite oxide of Ce and Pr, and Ru, the Ru content was 3 parts by mass with respect to 100 parts by mass of the composite oxide, and the molar ratio between Ce and Pr was Ce:Pr=99:1. When the density of the pellet catalyst was measured in the same manner as in Example 1, it was 0.96 g/cm³.

### Example 4

A pellet catalyst was obtained in the same manner as in Example 2 except that the amounts of cerium nitrate (III) hexahydrate and praseodymium nitrate (III) hexahydrate were changed so that, in the catalyst containing a carrier containing a composite oxide of Ce and Pr, and Ru, the Ru content was 3 parts by mass with respect to 100 parts by mass of the composite oxide, and the molar ratio between Ce and Pr was Ce:Pr=98:2. When the density of the pellet catalyst was measured in the same manner as in Example 1, it was 0.96 g/cm³.

### Example 5

A pellet catalyst was obtained in the same manner as in Example 2 except that the amounts of cerium nitrate (III) hexahydrate and praseodymium nitrate (III) hexahydrate were changed so that, in the catalyst containing a carrier containing a composite oxide of Ce and Pr, and Ru, the Ru content was 3 parts by mass with respect to 100 parts by mass of the composite oxide, and the molar ratio between Ce and Pr was Ce:Pr=50:50. When the density of the pellet catalyst was measured in the same manner as in Example 1, it was 1.02 g/cm³.

### Example 6

A pellet catalyst was obtained in the same manner as in Example 2 except that the amounts of cerium nitrate (III) hexahydrate and praseodymium nitrate (III) hexahydrate were changed so that, in the catalyst containing a carrier containing a composite oxide of Ce and Pr, and Ru, the Ru content was 3 parts by mass with respect to 100 parts by mass of the composite oxide, and the molar ratio between Ce and Pr was Ce:Pr=33:67. When the density of the pellet catalyst was measured in the same manner as in Example 1, it was 1.05 g/cm³.

### Comparative Example 1

A pellet catalyst containing a cerium oxide carrier and ruthenium (Ru) was obtained in the same manner as in Example 1 except that no praseodymium nitrate (III) hexahydrate was used and the amount of diammonium cerium nitrate (IV) was changed to 13.71 g. The Ru content in the pellet catalyst was 1.5 parts by mass with respect to 100 parts by mass of the cerium oxide. In addition, when the density of the obtained pellet catalyst was measured in the same manner as in Example 1, it was 1.87 g/cm³.

### Comparative Example 2

A pellet catalyst containing a cerium oxide carrier and ruthenium (Ru) was obtained in the same manner as in Example 2 except that no praseodymium nitrate (III) hexahydrate was used and 20.61 g of cerium nitrate (III) hexahydrate was used. The Ru content in the pellet catalyst was 3.0 parts by mass with respect to 100 parts by mass of the cerium oxide. In addition, when the density of the obtained pellet catalyst was measured in the same manner as in Example 1, it was 0.99 g/cm³.

### Comparative Example 3

A pellet catalyst containing a praseodymium oxide carrier and ruthenium (Ru) was obtained in the same manner as in Example 2 except that no cerium nitrate (III) hexahydrate was used and 20.88 g of praseodymium nitrate (III) hexahydrate was used. The Ru content in the pellet catalyst was 3.0 parts by mass with respect to 100 parts by mass of the praseodymium oxide. In addition, when the density of the obtained pellet catalyst was measured in the same manner as in Example 1, it was 1.05 g/cm³.

### Comparative Example 4

A pellet catalyst containing a magnesium oxide carrier and ruthenium (Ru) was obtained in the same manner as in Example 2 except that 51.97 g of magnesium nitrate (III) hexahydrate was used in place of cerium nitrate (III) hexahydrate and praseodymium nitrate (III) hexahydrate, and the amount of potassium carbonate was changed to 34.25 g. The Ru content in the pellet catalyst was 3.0 parts by mass with respect to 100 parts by mass of the magnesium oxide. In addition, when the density of the obtained pellet catalyst was measured in the same manner as in Example 1, it was 0.48 g/cm³. Ru dispersity and Ru particle size

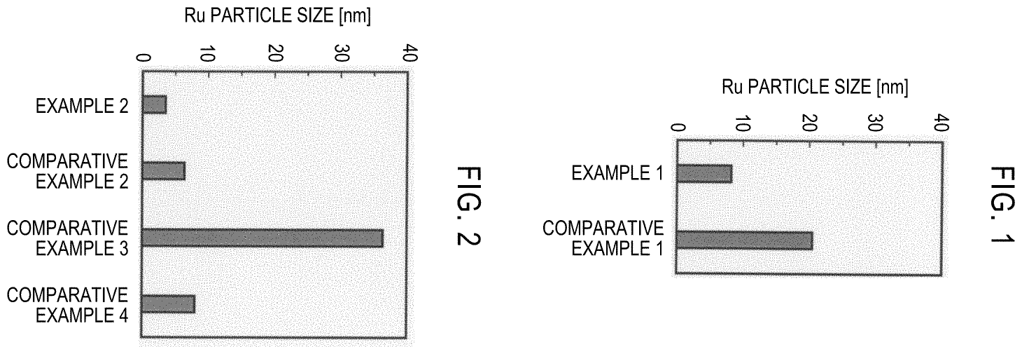

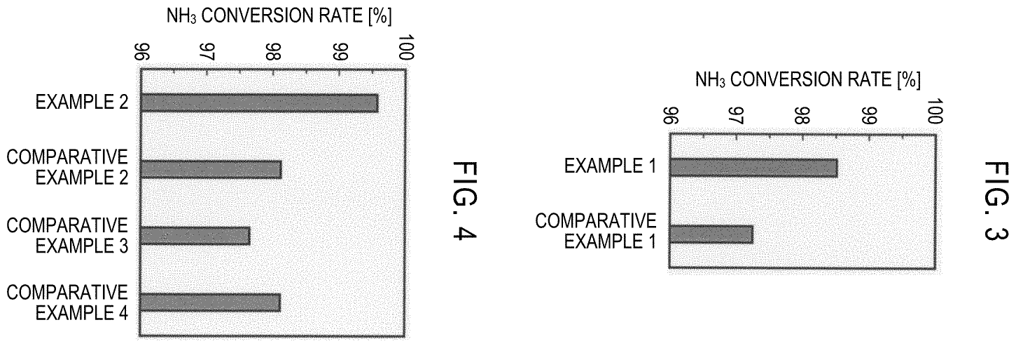

The Ru dispersity and the Ru particle size of the obtained pellet catalyst were measured by a CO pulse adsorption method. Specifically, 0.1 g to 0.3 g of a pellet catalyst was put into a U-shaped quartz glass reaction tube, a reduction treatment was performed at 550° C. for 15 minutes while supplying hydrogen gas at 20 ml/min thereto and a purge treatment was then performed at 550° C. for 20 minutes while supplying helium gas at 20 ml/min. Next, while helium gas was introduced at a flow rate of 20 ml/min, a catalyst bed was cooled to −78° C. and stabilized and then CO gas (100%) was introduced into a reaction tube at a temperature of −78° C. under a condition of 0.2974 ml/pulse in a pulsed manner, and CO was adsorbed on the pellet catalyst. The amount of CO adsorbed was determined from the amount of CO introduced and the amount of CO discharged in this case, the surface area of the Ru particles on the pellet catalyst was determined from the obtained amount of CO adsorption, and the Ru dispersity (%) and the Ru particle size (nm) were calculated from the obtained surface area of the Ru particles and the mass of Ru. The results are shown in Table 1 and FIG. 1 and FIG. 2.

TABLE 1

| | | | Ru | Ru | |
|---|---|---|---|---|---|
| | Ce:Pr | | content *¹ | particle | Ru |
| | (molar | Preparation | [parts | size | dispersity |
| | ratio) | method | by mass] | [nm] | [%] |
| Example 1 | 67:33 | Impregnation | 1.5 | 8.34 | 11.12 |
| | | method | | | |
| Example 2 | 67:33 | Coprecipitation | 3.0 | 3.74 | 24.66 |
| | | method | | | |
| Comparative | CeO₂ | Impregnation | 1.5 | 20.66 | 4.61 |
| Example 1 | | method | | | |
| Comparative | CeO₂ | Coprecipitation | 3.0 | 6.61 | 14.07 |
| Example 2 | | method | | | |
| Comparative | Pr₂O₃ | Coprecipitation | 3.0 | 36.55 | 2.55 |
| Example 3 | | method | | | |
| Comparative | MgO | Coprecipitation | 3.0 | 8.32 | 11.10 |
| Example 4 | | method | | | |

*¹ content with respect to 100 parts by mass of oxide

As shown in Table 1 and FIG. 1, it was found that, in the pellet catalyst on which Ru was supported by the impregnation method (Example 1 and Comparative Example 1), when a composite oxide of Ce and Pr (Example 1) was used as the carrier, it was possible to make the Ru particle size smaller than when cerium oxide (Comparative Example 1) was used. In addition, as shown in Table 1 and FIG. 2, it was found that, in the pellet catalysts in which Ru was contained by the coprecipitation method (Example 2 and Comparative Examples 2 to 4), when a composite oxide of Ce and Pr (Example 2) was used as the carrier, it was possible to make the Ru particle size smaller than when cerium oxide (Comparative Example 2), praseodymium oxide (Comparative Example 3) or magnesium oxide (Comparative Example 4) was used. In addition, it was found that, when Ru was contained in the composite oxide of Ce and Pr by the coprecipitation method (Example 2), it was possible to make the Ru particle size smaller than when it was supported by the impregnation method (Example 1).

Ammonia Decomposition Reaction

0.4 g of the pellet catalyst obtained in Example 1 and Comparative Example 1, 0.2 g of the pellet catalyst obtained in Examples 2 to 7 and Comparative Examples 2 and 3, and 0.1 g of the pellet catalyst obtained in Comparative Example 4 were filled into reaction tubes so that the volume of the catalyst bed was 0.2 cm³, this was adhered to a normal pressure fixed bed distribution type reaction device, and a thermocouple for measuring the catalyst bed temperature in the vicinity of the center of the catalyst bed was disposed. While a mixed gas containing 20% hydrogen/80% nitrogen was supplied to the catalyst bed at a flow rate of 40 ml/min, the reduction treatment was performed at 550° C. for 1 hour, and the heat treatment was then additionally performed at 650° C. for 2 hours. Next, 100% ammonia gas was caused to circulate the catalyst bed at a flow rate of 100 ml/min (corresponding to a space velocity of 30,000 h⁻¹), the ammonia decomposition reaction was caused at 500° C., the ammonia concentration in the catalyst exhaust gas was measured using a Fourier Transform infrared absorption type ammonia gas analyzer, and the ammonia conversion rate was determined. The results are shown in Table 2 and FIG. 3 and FIG. 4.

TABLE 2

| | | | Ru | |
|---|---|---|---|---|
| | Ce:Pr | | content *¹ | NH₃ |
| | (molar | Preparation | [parts | conversion |
| | ratio) | method | by mass] | rate [%] |
| Example 1 | 67:33 | Impregnation | 1.5 | 98.54 |
| | | method | | |
| Example 2 | 67:33 | Coprecipitation | 3.0 | 99.59 |
| | | method | | |
| Example 3 | 99:1 | Coprecipitation | 3.0 | 99.00 |
| | | method | | |
| Example 4 | 98:2 | Coprecipitation | 3.0 | 99.54 |
| | | method | | |
| Example 5 | 50:50 | Coprecipitation | 3.0 | 99.61 |
| | | method | | |
| Example 6 | 33:67 | Coprecipitation | 3.0 | 99.40 |
| | | method | | |
| Comparative | CeO₂ | Impregnation | 1.5 | 97.27 |
| Example 1 | | method | | |
| Comparative | CeO₂ | Coprecipitation | 3.0 | 98.14 |
| Example 2 | | method | | |
| Comparative | Pr₂O₃ | Coprecipitation | 3.0 | 97.67 |
| Example 3 | | method | | |
| Comparative | MgO | Coprecipitation | 3.0 | 98.14 |
| Example 4 | | method | | |

*¹ content with respect to 100 parts by mass of oxide

As shown in Table 2 and FIG. 3, it was confirmed that, in the pellet catalysts on which Ru was supported by the impregnation method (Example 1 and Comparative Example 1), when a composite oxide of Ce and Pr (Example 1) was used as the carrier, the ammonia conversion rate was higher and the ammonia decomposition activity was further improved than when cerium oxide (Comparative Example 1) was used. In addition, as shown in Table 2 and FIG. 4, it was confirmed that, in the pellet catalysts in which Ru was contained by the coprecipitation method (Example 2 and Comparative Examples 2 to 4), when a composite oxide of Ce and Pr (Example 2) was used as the carrier, the ammonia conversion rate was higher and the ammonia decomposition activity was further improved than when cerium oxide (Comparative Example 2), praseodymium oxide (Comparative Example 3) or magnesium oxide (Comparative Example 4) was used. In addition, it was confirmed that, when the Ru was contained in the composite oxide of Ce and Pr by the coprecipitation method (Example 2), the ammonia conversion rate was higher and the ammonia decomposition activity was further improved than when it was supported by the impregnation method (Example 1). This was thought to be caused by the fact that, when the composite oxide of Ce and Pr was used as the carrier, the Ru particle size decreased, and as a result, the number of active sites in the obtained pellet catalyst increased, and the catalytic activity was improved.

In addition, as shown in Table 1 to Table 2 and FIG. 1 to FIG. 4, the pellet catalyst obtained in Example 1 had a slightly larger Ru particle size than the pellet catalyst obtained in Comparative Example 2, but the ammonia conversion rate was high and the ammonia decomposition activity was excellent. It is thought that this is due to the factors other than the Ru particle size, such as improvement in the quality of the active sites due to the electronic action from Pr to Ru, and improvement in the reaction rate (turnover frequency) per active site.

Here, in the pellet catalyst obtained in Comparative Example 4, since the mass filled into the reaction tube was half and the amount of Ru in the catalyst bed was also half those of the pellet catalyst obtained in Example 2, it was thought that the ammonia conversion rate could decrease. Here, a pellet catalyst containing a magnesium oxide carrier and ruthenium (Ru) was prepared in the same manner as in Comparative Example 4 except that the Ru content with respect to 100 parts by mass of the magnesium oxide was changed to 6.0 parts by mass (twice the Ru content of the pellet catalyst obtained in Comparative Example 4), 0.1 g of the pellet catalyst was filled into the reaction tube, the ammonia decomposition reaction was performed in the same manner as above, but the ammonia conversion rate was not improved.

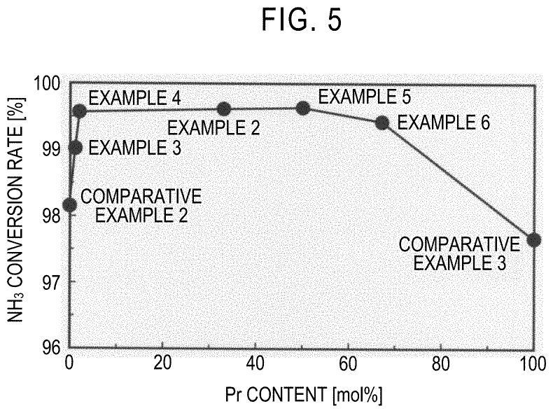

In addition, based on the results shown in Table 2, the ammonia conversion rates of the pellet catalysts in which Ru was contained by the coprecipitation method (Examples 2 to 6 and Comparative Examples 2 and 3) were plotted against the Pr content. The results are shown in FIG. 5. As shown in FIG. 5, it was confirmed that, when the composite oxide of Ce and Pr in which the Pr content was within a range of 1 mol % to 90 mol % (Examples 2 to 6) was used as the carrier, the ammonia conversion rate was higher and the ammonia decomposition activity was further improved that when cerium oxide (Comparative Example 2) or praseodymium oxide (Comparative Example 3) was used.

As described above, according to the present disclosure, it is possible to obtain an ammonia decomposition catalyst exhibiting a very strong ammonia decomposition activity under conditions of a high space velocity of ammonia gas and a low reaction temperature, particularly under these conditions even after exposure to a high temperature. Therefore, since the ammonia decomposition catalyst exhibiting such a very strong ammonia decomposition activity is used in the ammonia decomposition method of the present disclosure, it is useful as a method in which it is possible to efficiently decompose ammonia and generate hydrogen under conditions of a high space velocity of ammonia gas and a low reaction temperature, and particularly under these condition even after exposure to a high temperature.

What is claimed is:

1. An ammonia decomposition catalyst containing a carrier containing a composite oxide of cerium (Ce) and praseodymium (Pr), and ruthenium (Ru),
wherein the content of the composite oxide is 70 mass % or more with respect to the entire catalyst, and
wherein the molar ratio between Ce and Pr in the composite oxide is Ce:Pr=99:1 to 10:90.

2. The ammonia decomposition catalyst according to claim 1,
wherein the Ru content is 0.1 parts by mass to 10 parts by mass with respect to 100 parts by mass of the composite oxide.

3. A ammonia decomposition method, comprising
bringing ammonia into contact with the ammonia decomposition catalyst according to claim 1 and decomposing the ammonia in a temperature range of 450° C. to 650° C.
